(19) United States
(12) Patent Application Publication
(10) Pub. No.: US 2019/0323265 A1
(43) Pub. Date: Oct. 24, 2019

(54) LOCKING WEDGE FOR STORAGE DOOR

(71) Applicant: Janus International Group, LLC, Temple, GA (US)

(72) Inventors: Scott Alan ROBILLARD, Carrollton, GA (US); Curtis L. SCHROEDER, Carrollton, GA (US)

(21) Appl. No.: 16/387,866

(22) Filed: Apr. 18, 2019

Related U.S. Application Data
(60) Provisional application No. 62/660,710, filed on Apr. 20, 2018.

(51) Int. Cl. E05B 65/00; E06B 3/48; E06B 9/80

(52) U.S. Cl. CPC E05B 65/0021; E06B 2009/801; E06B 9/80; E06B 3/485

(57) ABSTRACT

According to the present disclosure, a storage facility includes a number of storage compartments and doors for controlling access to the storage compartments. The doors move along guide tracks between a lowered-closed position and a raised-opened position relative to respective entryways into the storage compartments. Latches are coupled to the doors for blocking movement of the doors at the selection of a user. One or more locks can be used with the doors to block access to the storage compartments.

### PRIORITY CLAIM

This application claims priority under 35 U.S.C. § 119(e) to U.S. Provisional Application Ser. No. 62/660,710, filed Apr. 20, 2018, the disclosure of which is expressly incorporated by reference herein in its entirety.

### BACKGROUND

The present disclosure relates to locks, and particularly to locks for doors. More particularly, the present disclosure relates to a removable lock for use with roll-up storage doors.

### SUMMARY

According to the present disclosure, a storage facility includes a number of storage compartments and doors for controlling access to the storage compartments. The doors move along guide tracks between a lowered-closed position and a raised-opened position relative to respective entryways into the storage compartments. Latches are coupled to the doors for blocking movement of the doors at the selection of a user. One or more locks can be used with the doors to block access to the storage compartments.

In illustrative embodiments, a locking wedge engages with the guide track and the door to block movement of the door at the selection of an authorized user. The locking wedge includes a frame, a head, and a lock. The head is coupled to the frame and extends through a slot in the guide track to block movement of the locking wedge along the guide track. The frame engages with corrugations of the door to block movement of the door relative to the guide track. The lock blocks removal of the locking wedge from the guide track at the selection of a user.

In illustrative embodiments, the lock includes a lock cylinder coupled to the frame and a cam coupled to the lock cylinder. The cam is movable between an unlocked position aligned with the frame and a locked position extending outward from the frame. The locking wedge can be mounted and dismounted relative to the guide track when the cam is in the unlocked position, and removal of the locking wedge from the guide track is blocked when the cam is in the locked position.

In illustrative embodiments, an authorized key allows a user to operate the lock cylinder and rotate the cam for mounting or dismounting the locking wedge relative to the door and the guide track.

In illustrative embodiments, the lock includes catch pins coupled to the head and a pin mover coupled to the catch pins. The catch pins extend outward from the head in an extended position to engage with the guide track and block removal of the locking wedge. The pin mover engages with the catch pins to move the catch pins toward one another to a retracted position to allow removal of the locking wedge from the guide track at the selection of a user.

In illustrative embodiments, the lock is an electronic lock and includes the catch pins, the pin mover, a motor, a battery, and a control board. The control board controls the delivery of power from the battery to the motor for controlling operation of the motor. The pin mover is coupled to the motor. Activation of the motor by an authorized user causes rotation of the pin mover to move the catch pins to the retracted position.

### BRIEF DESCRIPTION OF THE DRAWINGS

The drawings disclose exemplary embodiments in which like reference characters designate the same or similar parts throughout the figures of which:

FIG. 1 is a perspective view of a storage facility having a number of storage compartments and doors for controlling access to the compartments and suggesting that a locking wedge in accordance with the present disclosure is used to block the door from opening at the selection of an authorized user;

FIG. 2 is an enlarged view of FIG. 1 showing the locking wedge inserted into a guide track and engaged with corrugations of the door to block movement of the door relative to the guide track;

FIG. 3 is an upper perspective view of the locking wedge of FIG. 2 showing that the locking wedge includes a frame, a window formed through the frame, a head coupled to one end of the frame, and a turn lock coupled to an opposing end of the frame;

FIG. 4 is a lower perspective view of the locking wedge of FIG. 3 showing an authorized key inserted into the lock cylinder of the turn lock and suggesting that the authorized key can be rotated to rotate the cam;

FIG. 5 is a similar view to FIG. 4 showing the authorized key rotated to rotate the cam relative to the frame for engagement with the guide track to block removal of the locking wedge from the guide track at the selection of an authorized user;

FIG. 6 is an exploded assembly view of the locking wedge of FIG. 3 showing that the turn lock includes a lock cylinder and a cam coupled to the lock cylinder and suggesting that the lock cylinder extends through the frame into the window and that the cam attaches to the lock cylinder for movement in the window relative to the frame;

FIG. 7 is a side elevation view of the locking wedge of FIG. 3 showing that the frame defines a profile to allow the locking wedge to be inserted into the guide track and engage with the corrugations of the door;

FIG. 8 is an inside perspective view of a door assembly of the storage facility of FIG. 1;

FIG. 9 is a sectional view taken along line 9-9 in FIG. 8;

FIG. 10 is a front perspective view of the locking wedge of FIG. 3 showing the head extending from the frame and suggesting that the head is arranged to pass through a slot of the guide track, as suggested in FIGS. 11 and 12;

FIG. 11 is an enlarged view of FIG. 9 showing that the slot is formed in the guide track to align between corrugations of the door with the door in a closed position;

FIG. 12 is a sectional view taken along line 12-12 in FIG. 11 showing the head of the locking wedge inserted through the slot of the guide track to block movement of the locking wedge along the guide track and suggesting that the cam of the turn lock is rotated to engage with the guide track to block removal of the locking wedge from the guide track at the selection of an authorized user;

FIG. 13 is a perspective view of another embodiment of a locking wedge in accordance with the present disclosure showing that the locking wedge includes a frame defining an internal electronics compartment, a head coupled to the frame, and an electronic lock assembly;

FIG. 14 is a view similar to FIG. 13 showing portions of the locking wedge in phantom and that the electronic lock assembly includes catch pins, a servo motor, a battery, and a control board and suggesting that a pin mover is coupled to the servo motor and engaged with the catch pins for moving the catch pins with activation of the servo motor;

FIG. 15 is a perspective view of the catch pins and pin mover of FIG. 14 showing that each catch pin includes a body and a seat and suggesting that rotation of the pin mover drives the catch pins from an extended position toward one another against the bias of springs positioned between the catch pins; and

FIG. 16 is a similar view to FIG. 15 showing the catch pins moved to a retracted position.

The exemplification set out herein illustrates embodiments of the disclosure that are not to be construed as limiting the scope of the disclosure in any manner. Additional features of the present disclosure will become apparent to those skilled in the art upon consideration of the following detailed description of illustrative embodiments exemplifying the best mode of carrying out the disclosure as presently perceived.

### DETAILED DESCRIPTION

While the present disclosure may be susceptible to embodiment in different forms, there is shown in the drawings, and herein will be described in detail, embodiments with the understanding that the present description is to be considered an exemplification of the principles of the disclosure. The disclosure is not limited in its application to the details of structure, function, construction, or the arrangement of components set forth in the following description or illustrated in the drawings. The disclosure is capable of other embodiments and of being practiced or of being carried out in various ways. In addition, it is to be understood that the phraseology and terminology used herein is for the purpose of description and should not be regarded as limiting. The use of various phrases and terms is meant to encompass the items or functions identified and equivalents thereof as well as additional items or functions. Unless limited otherwise, various phrases, terms, and variations thereof herein are used broadly and encompass all variations of such phrases and terms. Furthermore, and as described in subsequent paragraphs, the specific configurations illustrated in the drawings are intended to exemplify embodiments of the disclosure. However, other alternative structures, functions, and configurations are possible which are considered to be within the teachings of the present disclosure. Furthermore, unless otherwise indicated, the term “or” is to be considered inclusive.

The foregoing terms as well as other terms should be broadly interpreted throughout this application to include all known as well as all hereafter discovered versions, equivalents, variations and other forms. The present disclosure is intended to be broadly interpreted and not limited.

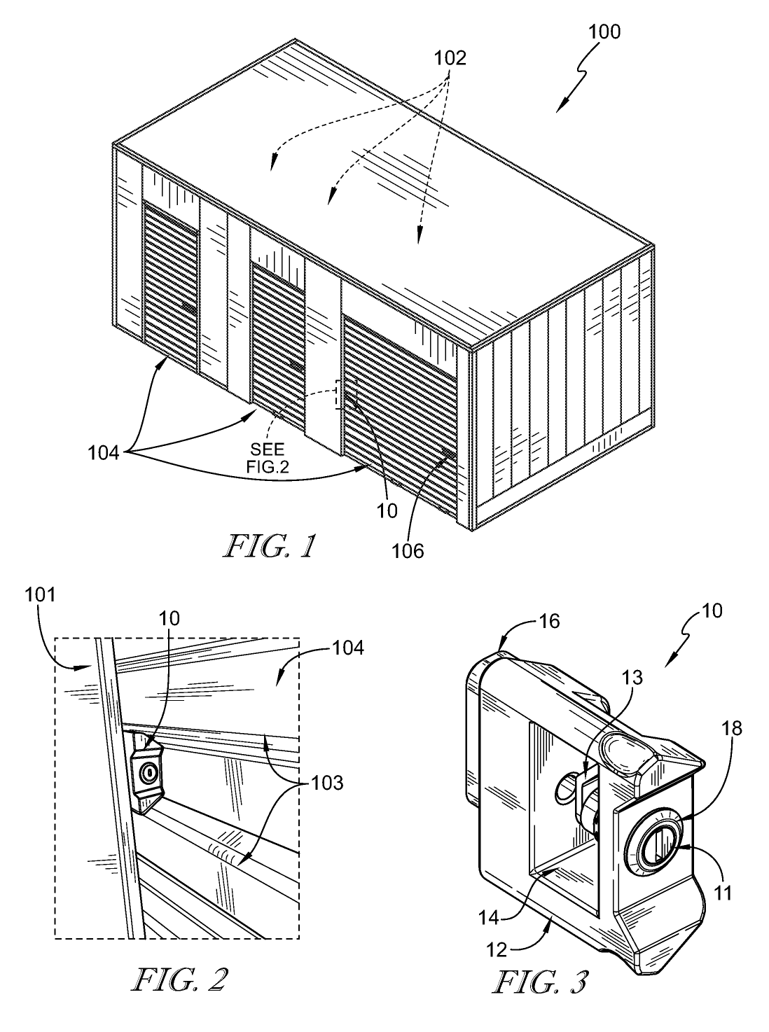

A storage facility 100 having a number of storage compartments 102 and doors 104 (sometimes called curtains) for controlling access to storage compartments 102 is shown in FIG. 1. In the illustrative embodiment, doors 104 are each roll-up doors that move vertically (in the orientation of FIG. 1) between a lowered-closed position and a raised-opened position relative to respective entryways into storage compartments 102. Latches 106 coupled to doors 104 can be used to block opening of doors 104 at the selection of a user. In some embodiments, a lock (such as a padlock) can be engaged with latches 106 to block access to storage compartments 102 by unauthorized users. In some embodiments, mechanisms within storage compartments 102 engage with doors 104 to block or allow access at the selection of authorized users.

Latches 106 and other locking devices normally used with doors 104 can become inoperable or require maintenance, leaving doors 104 unlocked and allowing access to storage compartments 102 by unauthorized users. In the illustrative embodiment, a locking wedge 10 in accordance with the present disclosure can be engaged with doors 104 to hold doors 104 in a closed position and block access to storage compartments 102 at the selection of an authorized user as suggested in FIGS. 1 and 2. Locking wedge 10 is inserted into a guide track 101 and engages with corrugations 103 of door 104 to block movement of door 104 relative to guide track 101.

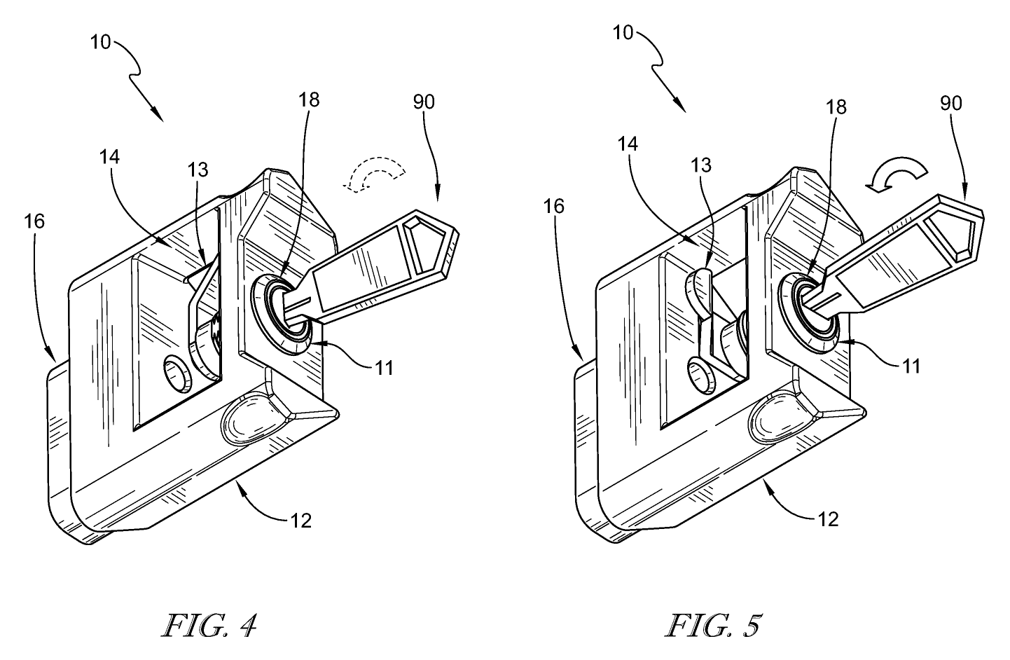

One exemplary embodiment of a locking wedge 10 is shown in FIG. 3. Locking wedge 10 includes a frame 12, a head 16 coupled to one end of frame 12, and a turn lock 18 coupled to an opposing end of frame 12. A window 14 is formed through frame 12. The components of locking wedge 10, including frame 12, head 16, and turn lock 18, can be formed from various rigid materials, such as polymers, metals, and metal alloys. Turn lock 18 includes a lock cylinder 11 coupled to frame 12 and a cam 13 coupled to lock cylinder 11 for movement relative to frame 12 as suggested in FIGS. 4 and 5. An authorized key 90 allows a user to operate turn lock 18 for mounting or dismounting locking wedge 10 relative to door 104 and guide track 101. Cam 13 is movable between an unlocked position arranged within window 14, as shown in FIG. 4, and a locked position extending out of window 14, as shown in FIG. 5. Locking wedge 10 can be mounted and dismounted relative to guide track 101 when cam 13 is in the unlocked position. Removal of locking wedge 10 from guide track 101 is blocked when cam 13 is in the locked position.

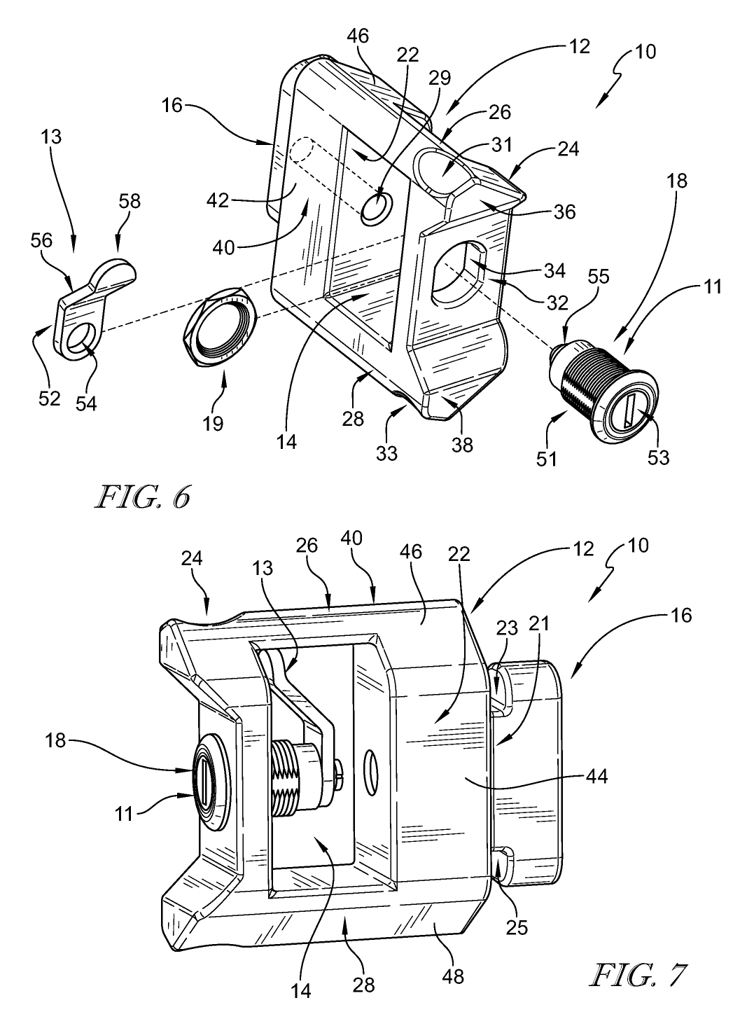

Frame 12 of locking wedge 10 includes a base 22 and a grip 24 connected by bridges 26, 28 as shown in FIG. 6. Base 22 is spaced apart from grip 24, and bridges 26, 28 are spaced apart from one another and extend between base 22 and grip 24. Base 22, grip 24, and bridges 26, 28 together define window 14. Head 16 is coupled to and extends from base 22. A bore 29 extends through head 16 and base 22. In the illustrative embodiment, a neck 28 is coupled between head 16 and base 22 as shown in FIG. 7. Neck 28 spaces head 16 away from base 22 to define slots 21, 23. In some embodiments, slots 21, 23 engage with guide track 101 to assist in holding locking wedge 10 in a mounted position as suggested in FIG. 2.

Grip 24 of frame 12 includes a wall 32, a receiver 34 formed through wall 32, and extensions 36, 38 extending outward from wall 32 away from base 22 as shown in FIG. 6. Lock cylinder 11 of turn lock 18 is inserted into receiver 34 and a nut 19 engages with lock cylinder 11 to hold lock cylinder 11 on frame 12. In the illustrative embodiment, each extension 36, 38 is formed to define a pad 31, 33, respectively. A user of locking wedge 10 engages with grip 24 for mounting and dismounting locking wedge 10 relative to guide track 101. Pads 31, 33 provide improved traction for a user to engage with grip 24. Extensions 36, 38 allow locking wedge 10 to be inserted into guide track 101 to a depth such that access to window 14 and cam 13 is blocked by guide track 101 when locking wedge 10 is mounted as suggested in FIG. 2. In some embodiments, locking wedge 10 does not include extensions 36, 38 and a user engages with a portion of wall 32 for mounting and dismounting locking wedge 10.

Frame 12 defines a contour 40 to allow locking wedge 10 to engage with guide track 101 and door 104 as suggested in FIGS. 6, 7, and 11. Contour 40 includes an outside surface 42, an inside surface 44, and beveled surfaces 46, 48 as shown in FIGS. 6 and 7. Outside surface 42 extends along and engages with guide track 101 when locking wedge 10 is mounted. Inside surface 44 is spaced apart from outside surface 42 such that locking wedge 10 substantially fills a gap between guide track 101 and door 104 as suggested in FIG. 2. Beveled surfaces 46, 48 are positioned at an acute angle with respect to one another such that beveled surfaces 46, 48 extend away from one another from the inside surface 44 to the outside surface 42 as shown in FIGS. 6 and 7. Inside surface 44 and beveled surfaces 46, 48 engage with door 104, including corrugations 103 of door 104, when locking wedge 10 is mounted as suggested in FIG. 2.

Locking cylinder 11 of turn lock 18 includes a barrel 51, a plug 53 coupled to barrel 51, and a fastener 55 coupled to plug 53 as shown in FIG. 6. Plug 53 is configured to engage with barrel 51 and block rotation when no key or an unauthorized key is inserted into lock cylinder 11, or to allow rotation when an authorized key is inserted. Fastener 55 rotates with plug 53. In the illustrative embodiment, an outer surface of barrel 51 is threaded for engagement with inner threads of nut 19. Receiver 34 of grip 24 is shaped to engage with barrel 51 to block rotation of barrel 51 relative to frame 12.

Cam 13 of turn lock 18 includes a connector 52, and arm 56 coupled to connector 52, and a finger 58 coupled to arm 56 as shown in FIG. 6. A hole 54 is formed through connector 52 for mounting of cam 13 on fastener 55 of lock cylinder 11. In the illustrative embodiment, fastener 55 aligns with bore 29 to allow a tool, such as a screwdriver, to extend through bore 29 and engage with fastener 55 for mounting cam 13 on lock cylinder 11. Arm 56 of cam 13 is bent relative to connector 52 to position finger 58 toward wall 32 of grip 24 when cam 13 is mounted on lock cylinder 11. In some embodiments, cam 13 is flat. Cam 13 rotates with rotation of plug 53 and fastener 55 relative to barrel 51.

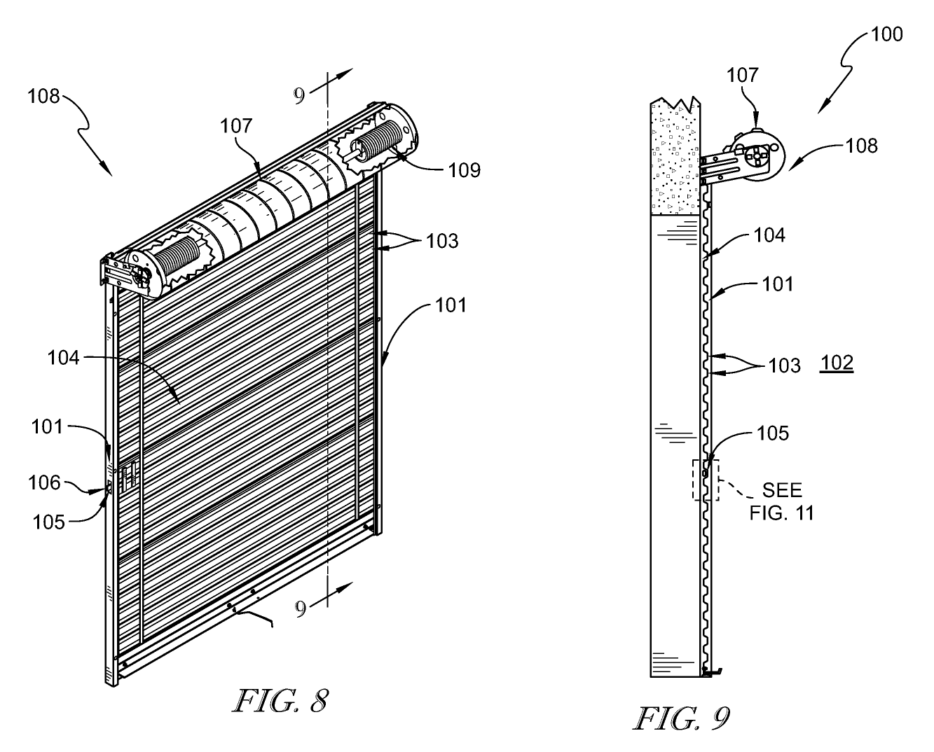

An illustrative door assembly 108 is shown in FIG. 8. Door assembly 108 includes guide tracks 101, door 104, and a barrel 107. Guide tracks 101 and barrel 107 are coupled to an inside portion of storage compartment 102 as suggested in FIG. 9. Door 104 is shown in a closed position in FIG. 8 and moves to an open position by raising and collecting around barrel 107. One or more springs 109 bias door 104 toward an opened position to assist a user with opening door 104. Latch 106 engages with a slot 105 formed in guide track 101 to block movement of door 104 relative to guide track 101 at the selection of a user.

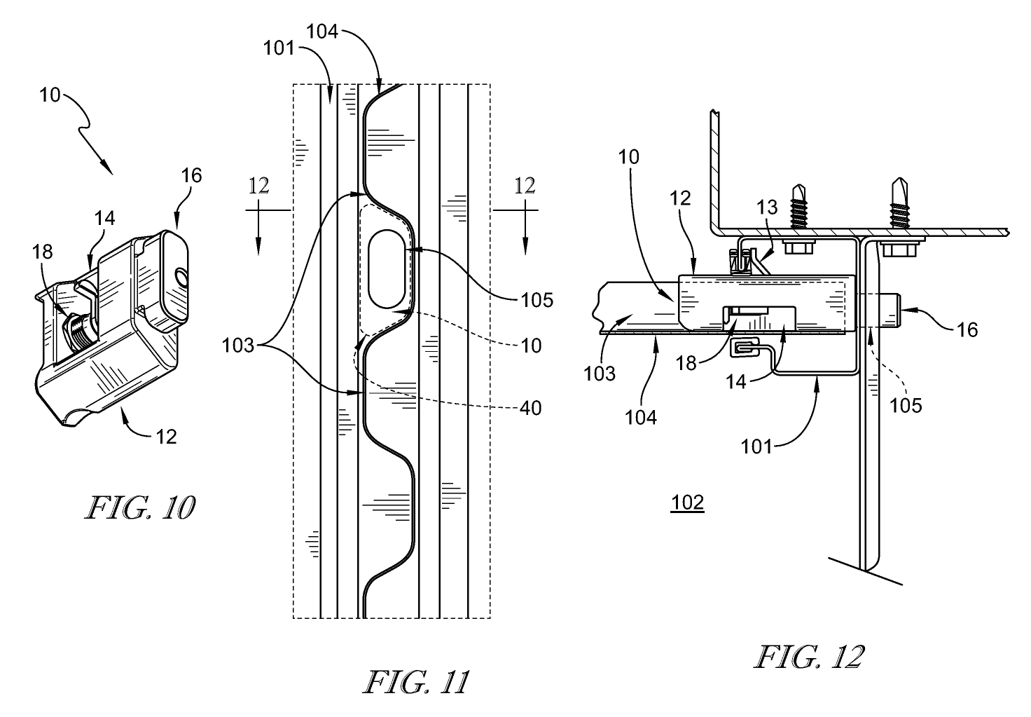

Frame 12 of locking wedge 10 is sized and shaped to fit within and engage along corrugations 103 as suggested in FIGS. 10-12. Head 16 of locking wedge 10 is sized and shaped to be inserted through slot 105 in guide track 101. Head 16 engages with guide track 101, and frame 12 engages with door 104, to block movement of door 104 relative to guide track 101. Cam 13 of turn lock 18 engages with an inside portion of guide track 101 to block removal of locking wedge 10 from guide track 101 at the selection of an authorized user.

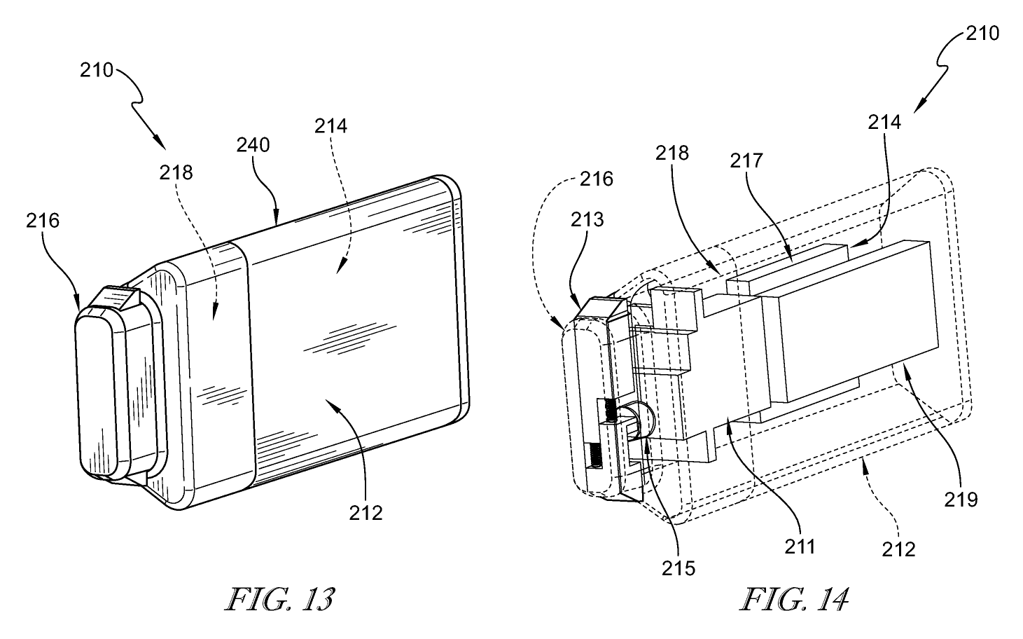

Another embodiment of a locking wedge 210 in accordance with the present disclosure is shown in FIGS. 13 and 14. In the illustrative embodiment, locking wedge 210 includes a frame 212 defining an internal electronics compartment 214, a head 216 coupled to frame 212, and an electronic lock assembly 218 coupled to frame 212. Frame 212 also defines a contour 240 similar to contour 40 of locking wedge 10.

Electronic lock assembly 218 includes catch pins 213, a servo motor 211, a battery 217, and a control board 219 as shown in FIG. 14. A pin mover 215 is coupled to servo motor 211 and engages with catch pins 213 for moving catch pins 213 relative to head 216 with activation of servo motor 211 at the selection of an authorized user. In some embodiments, control board 219 includes a wireless transmitter/receiver, such as a BLUETOOTH, wi-fi, or near field communication (NFC) device, that allows an external signal device, such as a smartphone or keycard, to activate servo motor 211 and allow removal of locking wedge 210 from a mounted position blocking door 104 at the selection of an authorized user.

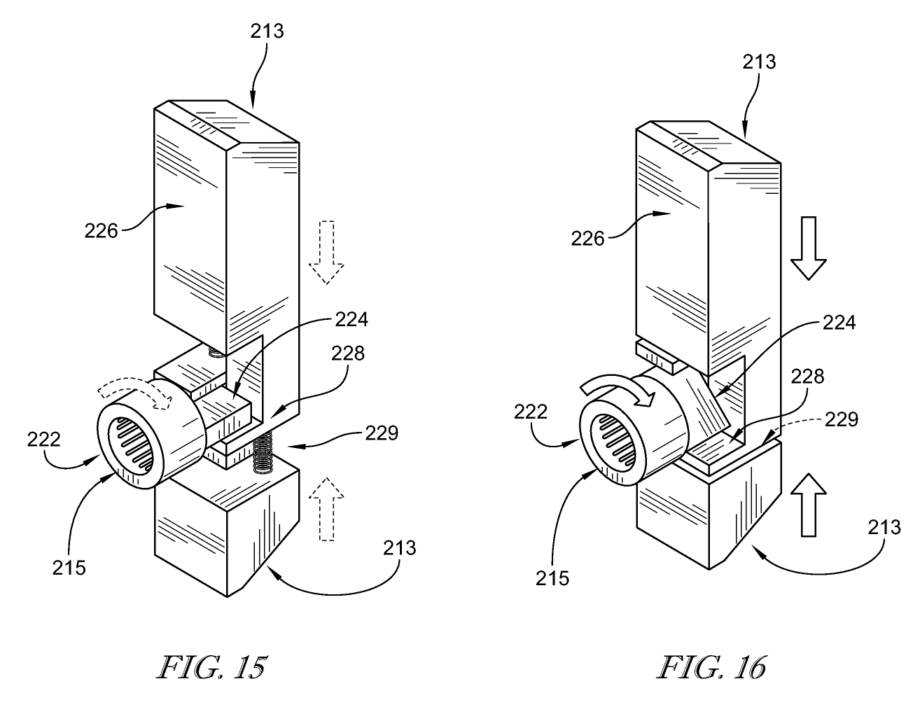

Catch pins 213 extend outward from head 216 in an extended position to engage with guide track 101 and block removal of locking wedge 210 as suggested in FIGS. 15 and 16. Pin mover 215 includes a connector 222 for coupling pin mover 215 with servo motor 211 and a flange 224 coupled to connector 222 as shown in FIG. 13. Each catch pin 213 includes a body 226 and a seat 228 coupled to body 226. One or more springs 229 engage with catch pins 213 to bias catch pins 213 toward the extended position. Activation of servo motor 211 by an authorized user causes rotation of pin mover 215 and engages flange 224 with seats 228 of catch pins 213 to move catch pins 213 toward one another against the bias of springs 229 as suggested in FIGS. 15 and 16.

Locking wedge 210 can be mounted relative to guide track 101 and door 104 similar to locking wedge 10. In the mounted position, head 216 extends through slot 105 and frame 212 engages with door 104 to block movement of door 104 to an opened position. Catch pins 213, in the extended position, engage with guide track 101 to block head 216 from passing out of slot 105. In some embodiments, turn lock 18 of locking wedge 10 includes catch pins 213 and pin mover 215, and lock cylinder 11 is coupled to pin mover 215 for movement of catch pins 213 with rotation of an authorized key 90.

While the present disclosure describes various exemplary embodiments, the disclosure is not so limited. To the contrary, the disclosure is intended to cover various modifications, uses, adaptations, and equivalent arrangements based on the principles disclosed. Further, this application is intended to cover such departures from the present disclosure as come within at least the known or customary practice within the art to which it pertains. It is envisioned that those skilled in the art may devise various modifications and equivalent structures and functions without departing from the spirit and scope of the disclosure as recited in the following claims. The scope of the following claims is to be accorded the broadest interpretation to encompass all such modifications and equivalent structures and functions.

What is claimed is:

1. A locking wedge for use with a corrugated roll-up door, the roll-up door engaged with a guide track for movement along the guide track between a lowered-closed position and a raised-opened position, the locking wedge comprising:
a frame;
a head coupled to the frame; and
a lock coupled to the frame,
wherein, in a mounted position of the locking wedge, the head engages with the guide track and the frame engages with the roll-up door to block movement of the roll-up door relative to the guide track, and the lock engages with the guide track to block removal of the locking wedge from the guide track at the selection of a user.

2. The locking wedge of claim 1, wherein, in the mounted position, the head extends through a slot in the guide track to block movement of the locking wedge along the guide track.

3. The locking wedge of claim 2, wherein, in the mounted position, the frame engages with corrugations of the roll-up door to block movement of the roll-up door relative to the guide track.

4. The locking wedge of claim 3, wherein the frame defines a contour to allow the locking wedge to be mounted between the guide track and the roll-up door and between adjacent corrugations of the roll-up door.

5. The locking wedge of claim 4, wherein the contour includes an outside surface, an inside surface, and beveled surfaces, wherein, in the mounted position, the outside surface extends along and engages with guide track, the inside surface is spaced apart from outside surface such that the locking wedge substantially fills a gap between guide track and the roll-up door, and the inside surface and beveled surfaces engage with the roll-up door.

6. The locking wedge of claim 5, wherein the beveled surfaces are positioned at an acute angle with respect to one another such that the beveled surfaces extend away from one another from the inside surface to the outside surface.

7. The locking wedge of claim 1, wherein the lock includes a lock cylinder coupled to the frame and a cam coupled to the lock cylinder, wherein the cam is movable between an unlocked position aligned with the frame and a locked position extending outward from the frame, and wherein the lock cylinder controls movement of the cam.

8. The locking wedge of claim 7, wherein the locking cam, in the unlocked position, allows mounting and dismounting of the locking wedge relative to the guide track, and wherein the cam engages with the guide track, in the locked position, to block removal of the locking wedge from the guide track.

9. The locking wedge of claim 8, wherein an authorized key allows a user to operate the lock cylinder and rotate the cam.

10. The locking wedge of claim 1, wherein the lock includes catch pins coupled to the head and a pin mover coupled to the catch pins, wherein the catch pins extend outward from the head in an extended position to engage with the guide track and block removal of the locking wedge, and wherein the pin mover engages with the catch pins to move the catch pins toward one another to a retracted position to allow removal of the locking wedge from the guide track at the selection of a user.

11. The locking wedge of claim 10, wherein the lock further includes a motor, a battery, and a control board, wherein the control board controls delivery of power from the battery to the motor for controlling operation of the motor, wherein the pin mover is coupled to the motor, and wherein activation of the motor by an authorized user causes rotation of the pin mover to move the catch pins to the retracted position.

12. A locking wedge comprising:
a frame, the frame defining a contour including an outside surface, an inside surface spaced apart from the outside surface, and beveled surfaces extending between the outside and inside surfaces, the beveled surfaces positioned at an acute angle with respect to one another such that the beveled surfaces extend away from one another from the inside surface to the outside surface;
a head coupled to the frame; and
a lock coupled to the frame.

13. The locking wedge of claim 12, wherein the frame includes a base and a grip coupled to the base by spaced apart bridges, wherein the base is spaced apart from the grip, and wherein the base, grip, and bridges together define a window through the frame.

14. The locking wedge of claim 13, wherein the lock includes a lock cylinder coupled to the grip and a cam coupled to the lock cylinder, wherein the cam is movable within the window between an unlocked position aligned with the frame and a locked position extending outward from the frame, and wherein the lock cylinder controls movement of the cam.

15. The locking wedge of claim 14, wherein the head is coupled to and extends from the base.

16. The locking wedge of claim 14, wherein the grip includes a wall, a receiver formed through the wall, and extensions extending outward from the wall away from the base, wherein the lock cylinder is inserted into the receiver.

17. The locking wedge of claim 16, wherein each extension is formed to define a pad for engagement by a user.

18. The locking wedge of claim 14, wherein an authorized key allows a user to operate the lock cylinder and rotate the cam.

19. The locking wedge of claim 12, wherein the lock includes catch pins coupled to the head and a pin mover coupled to the catch pins, wherein the catch pins extend outward from the head in an extended position, and wherein the pin mover engages with the catch pins to move the catch pins toward one another to a retracted position at the selection of a user.

20. The locking wedge of claim 19, wherein the lock further includes a motor, a battery, and a control board, wherein the control board controls delivery of power from the battery to the motor for controlling operation of the motor, wherein the pin mover is coupled to the motor, and wherein activation of the motor by an authorized user causes rotation of the pin mover to move the catch pins to the retracted position.
